(19) United States
(12) Patent Application Publication
(10) Pub. No.: US 2013/0226614 A1
(43) Pub. Date: Aug. 29, 2013

(54) SYSTEM AND METHOD FOR MEASURING HEALTH CARE OUTCOMES

(71) Applicant: Health Now! Inc., (US)

(72) Inventor: Laith Bustani, Ontario (CA)

(73) Assignee: HEALTH NOW! INC., Ottawa (CA)

(21) Appl. No.: 13/776,257

(22) Filed: Feb. 25, 2013

Related U.S. Application Data
(60) Provisional application No. 61/602,463, filed on Feb. 23, 2012.

(51) Int. Cl. G06F 19/00

(52) U.S. Cl. CPC G06F 19/324
USPC 705/3

(57) ABSTRACT

A system for measuring health care outcomes is provided. The system includes a health care interaction database, electronically accessible over at least one network system. A health care outcome assessment tool is hosted at least partially on the health care interaction database. The health care outcome assessment tool is configured to assess a change in a patient's health based on coded information relating to a health care interaction accessed from the health care interaction database.

### CROSS REFERENCE TO RELATED APPLICATION

This application claims benefit to U.S. Provisional Patent Application Ser. No. 61/602,463, filed Feb. 23, 2012, which is incorporated herein by reference.

### FIELD OF THE DISCLOSURE

The present disclosure is generally related to measuring health outcomes, and more particularly is related to a system and method for measuring health outcomes resulting from self-directed interventions by a single person, and/or interactions between any two or more individuals. The disclosure has particular utility in the healthcare arena, for measuring the outcome of interactions between a patient and a health care provider, e.g. a doctor, and will be described in connection with such utility, although other utilities are contemplated.

### BACKGROUND OF THE DISCLOSURE

An important aspect in medical care involves determining the effectiveness of a particular medical intervention or course of treatment. In this regard, of primary importance in this determination is the patient's response to the treatment. This includes perceptual (subjective) analysis on the part of the patient, the doctor or both. Patients frequently are not able to accurately and/or efficiently communicate the pattern of health changes over time. For example, while a patient's response to a particular pharmaceutical agent may be measured by blood pressure readings, weight, and lab values that are easily quantified, these measures are often indirect approximations of health. If the patient's energy is drained and their function limited secondary to side effects of the medication, the conclusion, for example, that a 10 mmHg reduction in blood pressure and 2% relative risk reduction of stroke constitutes a treatment success may be false. Direct assessment of health is highly subjective and hard to standardize, thus limiting their measurement and reporting. The exclusion of these subjective impressions leads to an incomplete representation of the patient's experience that can lead to inaccurate conclusions as the merits/consequences of a given course of action.

In every health care related intervention (i.e. an attempt by an individual to adapt and self-manage a health challenge) and interaction (i.e. an encounter between a patient and a health care provider) a wealth of information, regarding both the patient's and the provider's perceptions of the patient's health, is often produced, some of which may be beneficially used to more accurately measure health care outcomes. However, the vast majority of this information is not uniformly captured, or is captured in a manner that renders aggregating and analysis difficult.

Thus, a heretofore unaddressed need exists in the industry to address the aforementioned deficiencies and inadequacies.

### SUMMARY OF THE DISCLOSURE

Embodiments of the present disclosure provide a system for measuring health outcomes. Briefly described, in architecture, one embodiment of the system, among others, can be implemented as follows. The system for measuring health outcomes includes a health interaction database, electronically accessible over at least one network system. A health outcome assessment tool is hosted at least partially on the health interaction database. The health outcome assessment tool is configured to capture perceived changes in a patient's health based on coded information relating to a health interaction accessed from the health interaction database. These perceptions can be from the patient themselves, such as in the case of self-management of a health challenge, or from anyone else the patient choses to seek an opinion from with respect to that challenge.

In another embodiment, a method for measuring health outcomes is provided that includes the steps of: providing a health interaction database, electronically accessible over at least one network system; and providing a health outcome assessment tool hosted at least partially on the health intervention and/or interaction database. The health outcome assessment tool is configured to assess a change in a patient's health based on coded information relating to a health interaction accessed from the health intervention and/or interaction database.

In yet another embodiment, a non-transitory computer readable medium is provided that contains instructions for providing a method for measuring health outcomes enabled at least in part on a processor of a computerized device, wherein a health intervention and/or interaction database is electronically accessible by the processor, and a health outcome assessment tool is hosted at least partially on the health intervention and/or interaction database. The instructions, which when executed by the processor, perform the step of assessing a change in a patient's health based on coded information relating to a health interaction accessed from the health interaction database.

Other systems, methods, features, and advantages of the present disclosure will be or become apparent upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic illustration of a system for measuring health care outcomes, in accordance with a first exemplary embodiment of the present disclosure.

FIG. 2 is a flow chart illustrating a method for measuring health care outcomes, in accordance with the first exemplary embodiment of the present disclosure.

FIG. 3 is a schematic illustration of a system for measuring health care outcomes, in accordance with a second exemplary embodiment of the present invention.

### DETAILED DESCRIPTION

Many embodiments of the disclosure may take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured or constructed to perform one or more of the computer-executable algorithms described below. Accordingly, the term “computer” as generally used herein refers to any data processor and includes Internet appliances, hand-held devices (including palm-top computers, wearable computers, cellular or mobile phones, multi-processor systems, processor-based or programmable consumer electronics, network computers, minicomputers) and the like.

The disclosure also can be practiced in distributed computing environments, where tasks or modules are performed by remote processing devices that are linked through a communications network. Moreover, the disclosure can be practiced in Internet-based or cloud computing environments, where shared resources, software and information may be provided to computers and other devices on demand. In a distributed computing enviromnent, program modules or subroutines may be located in both local and remote memory storage devices. Aspects of the disclosure described below may be stored or distributed on computer-readable media, including magnetic and optically readable and removable computer disks, fixed magnetic disks, floppy disk drive, optical disk drive, magneto-optical disk drive, magnetic tape, hard-disk drive (HDD), solid state drive (SSD), compact flash or non-volatile memory, as well as distributed electronically over networks. Data structures and transmissions of data particular to aspects of the disclosure are also encompassed within the scope of the disclosure.

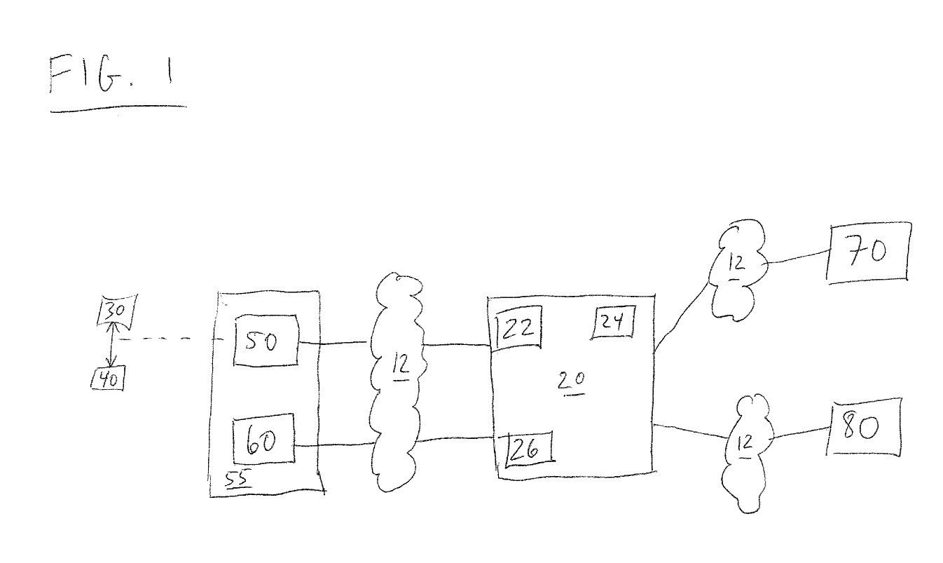

FIG. 1 is a schematic illustration of a system for measuring health care outcomes 10, in accordance with a first exemplary embodiment of the present disclosure. The system for measuring health care outcomes 10, which may also be referred to as ‘system 10’, includes a health care interaction database 20, electronically accessible over at least one network system 12. A sensor 50 is positioned to sense and/or record a health care interaction between a patient 30 and a doctor 40. However, 30 and 40 are not so limited, and may, for example, be a patient and a nurse, or a mother and a child or an elder and a caretaker, etc. An interaction coding/transcribing tool 60 is positioned to access the information sensed by the sensor 50. A health care outcome assessment tool 22 is hosted at least partially on the health care interaction database 20.

The health care interaction database 20 may include any database capable of storing and/or coordinating information, such as an electronic database, a computer and/or computerized server. Any type of electronic and/or computerized device that is capable of storing information may be included as the health care interaction database 20, and is considered within the scope of this disclosure. Any such electronic and/or computerized device, including any server, may include a processor for processing data and executing algorithms, including any of the processes and algorithms set forth in this disclosure. The health care interaction database 20 is electronically accessible over at least one network system 12. The network system 12 may include any type of network infrastructure, such as the Internet, or any other wired, wireless and/or partially wired network. The health care interaction database 20 and network system 12 may include a variety of hardware and software components to provide successful functioning of the health care interaction database 20, as is well-known within the art. Further, any features, characteristics, designs and/or functions that are known within the art may be included with the system 10 to further enhance its efficiency.

The health care interaction database 20 hosts the health care outcome assessment tool 22. The health care outcome assessment tool 22 may be fully or partially hosted on the health care interaction database 20. The health care interaction database 20 may also host a health care outcome assessment tool 22 that is located remote from the health care interaction database 20, such as by providing access to a remotely located health care outcome assessment tool 22, or by providing a link or other accessing entity to the health care outcome assessment tool 22. The health care outcome assessment tool 22 may include any tool, device, system, process or combination thereof, which assists with assessing some aspect of a health care outcome. For example, the health care outcome assessment tool 22 may quantify or score a change in a patient's health, based on one or more health care related interactions between the patient and a doctor. The health care outcome assessment tool 22 may include any computer-readable memory or databases, which may be stored in any computer-readable medium, and may be accessible by a computer processor. The health care outcome assessment tool 22 may further include or access computer program instructions which may cause a processor to perform any algorithms and/or functions which may be described in this disclosure.

The sensor 50 may be any sensor capable of sensing and/or recording a health care related interaction between a patient 30 and a doctor 40. The interaction may consist of, for example, a conversation between the patient 30 and his/her treating physician 40 during a clinical visit. The sensor 50 may be, for example, an audio recording device, a video recording device, and/or a combination audio and video recording device.

The interaction coding/transcribing tool 60 accesses information sensed by the sensor 50 and assigns codes to portions of the sensed information. The interaction coding/transcribing tool 60 may access information from the sensor 50 through a variety of ways, including through a computerized device in communication with the sensor 50 over a network system. For example, the interaction coding/transcribing tool 60 may be contained within, or accessible via, a computer 55. The sensor 50 may be, for example, a microphone, camera or any other audio and/or video recording device capable of communication with the computer 55 on which the interaction coding/transcribing tool 60 may be hosted. Alternatively, the interaction coding/transcribing tool 60 may include or be operated by a person, by accessing the interaction information sensed by the sensor 60 (e.g., a recorded audio file) and transcribing and coding the audio information into textual information using, for example, a keyboard. The transcribed and/or coded information may be input into the health care interaction database 20.

The codes identify certain aspects of the health care interaction. The codes may identify aspects of the health care interaction which pertain to, for example but not limited to: the identity of the parties involved in the interaction; the nature of the interaction; the time and place of interaction; the condition of the patient; the type of treatment administered; the objective of the treatment; the effectiveness of the treatment, and the like.

The coded information is input to the health care interaction database 20 via the interaction coding/transcribing tool 60. In one embodiment, the interaction coding/transcribing tool 60 includes software instructions or code stored in computer-readable memory on a computer 55. The sensor 50 may input sensed information directly into the computer 55, where it may be stored, for example, in computer readable memory. The interaction coding/transcribing tool 60 may access the sensed information, and may automatically transcribe the sensed information into text. Suitable techniques for directly transcribing audio information into text are well-known within the relevant field.

For example, the coding/transcribing tool 60 may comprise a human coder as being an important part of translating/abstracting the sum total of the sensor array data, the shared subjective impressions from both 30 and 40 and the digital recording 50 of the interaction. In some settings, the coded transaction would be secured/proprietary within a given institutions walls (e.g. insurance company, hospital, etc.) but as much as possible the non-proprietary and non-confidential elements (e.g. systolic blood pressure of 74 y/o diabetic male improved 10 mmHg after one week of Diltiazem 10 mg daily, but patient experienced leg swelling) would be abstracted and filed in a digital health interactions library (20) for future reference. Also, the coded information is fed-back to the patient and care provider (30 and 40) both for error-checking and feedback (ensure standards of care met, etc.). Coding could also be done by the patient and/or physician. Additionally, coding would serve as a powerful education tool for those training in the healthcare field.

The transcribed information may then be manually or automatically coded using the interaction coding/transcribing tool 60. The interaction coding/transcribing tool 60 may comprise program instructions for detecting certain words from the transcribed information and then coding, or applying a tag, to a portion of text (e.g., a line of conversation between the doctor and patient) based on the detected word. For example, the coding/transcribing tool 60 may be configured to detect the words: “patient name”, “physician name”, “time”, “place”, “objective”, “condition”, “symptoms”, “effectiveness of treatment”, and so on. Utilizing word and/or context recognition, the coding/transcribing tool 60 assigns or associates a code to particular portions of the health care interaction. The coded information may be stored in the health care interaction database 20.

By coding portions of the health care interaction, the health care interaction can be searched, ordered, quantified or otherwise organized and made accessible based on the codes. The health care assessment tool 22 may access the coded information, for example from the health care intervention database 20, and quantify changes in health based on the coded information. The health care assessment tool 22 may quantify the changes in health, for example, as being either an improvement (+) or a decline (−) in health. The quantification of changes in health may be based on both the patient's perception and the doctor's perception of the changes in health, which may be provided by the coded health care interaction. The quantified change in health may be associated with the particular patient and/or doctor to whom it pertains, and stored in a quantified health change database 24. The health change database 24 may be fully or partially hosted on the health care intervention database 20, or may be remotely located from, and capable of electronic communication with, the health care interaction database 20. A quantified score may be produced by the health care outcome assessment tool 22 indicating the change in health.

Access properties may be applied to or associated with the health care information stored in the health care intervention database 20 and/or the quantified health change database 24. For example, the access properties may include: private, shared and/or public. Information associated with an access property of “private” may only be accessible to the individual patient. Information associated with an access property of “shared” may be shared between two or more people according to a defined license. In such a case, the license specifies the terms under which the information can be used. A library of preconfigured licenses may be available, for example in license database 26, for individual patient use and selection. The license database 26 may be fully or partially hosted on the health care intervention database 20, or may be remotely located from, and capable of electronic communication with, the health care interaction database 20.

As shown in the following examples, the quantification of changes in health may be based on only one individual's (e.g., the patient) portion of the health care interaction (Example A), or the quantification of changes in health may be based on both the patient's and the doctor's perception of the health care interaction (Example B).

Example A illustrates a method of quantifying changes in health, based on only one individual's (e.g., the patient) portion of a health care interaction.

Example A: Individual Quantification of Changes in Health:

The Individual Quantification of Changes in Health is meant to illustrate the application of the process to an individual self-directing a care intervention. (Perceive and record): feel overweight (sensor array=weight=190, BMI 28). Intervention Strategy: Exercise: Description. “I circuit trained 30 minutes five times a week for one month.” Perceive/Record: “I felt better (+), and dropped to 182 lbs. with my BMI now 25.” “I will mark this as public and upload it to the health intervention database 20.”

This “consumer-driven” application is actually the marked entry-point. Here, there may not be a trainer coder. Rather, the use of semantics and context to the data points in combination with the binary (−/+) representation of the change in health forms the basis for more accurate outcome analysis.

a. Perceive and record the current state of health using a defined sensor array.
The current-state of a patient's health (i.e. “pre-intervention” state of health) may be perceived via an initial health care interaction between the patient 30 and a doctor 40. The interaction may be recorded using the sensor 50 and the current state of health may be coded using the interaction coding/transcribing tool 60 as described herein. For example, the interaction coding/transcribing tool 60 may identify the current state of health from the interaction using word and/or context recognition techniques. The current state of health may thus be associated with a code identifying the relevant portion of the health care interaction as the “current health.” The coded information may be added to the health care interaction database 20.

b. Identify the intervention strategy.
The intervention strategy may be identified from the initial health care interaction between patient 30 and doctor 40, or from any subsequent health care interactions between patient 30 and doctor 40. The intervention strategy may be identified using the interaction coding/transcribing tool 60. For example, the interaction coding/transcribing tool 60 may identify the intervention strategy from the interaction using word and/or context recognition techniques. The intervention strategy may thus be associated with a code identifying the relevant portion of the health care interaction as the “intervention strategy.” The coded information may be added to the health care interaction database 20.

c. Describe the intervention.
The intervention may be described within a health care interaction between patient 30 and doctor 40 and sensed by the sensor 50 and coded. The description of the intervention may be identified using the interaction coding/transcribing tool 60, for example, by using word and/or context recognition techniques. The description of the intervention (e.g., the treatments applied, and so on) may thus be associated with a code identifying the relevant portion of the health care interaction as the “intervention description.” The coded information may be added to the health care

d. Perceive and record the post-intervention state of health using a defined sensor array.
The post-intervention state of health may be described during a health care interaction between patient 30 and doctor 40, sensed by the sensor 50 and coded. The post-intervention state of health may be identified using the interaction coding/transcribing tool 60, for example, by using word and/or context recognition techniques. The post-intervention state of health may thus be associated with a code identifying the relevant portion of the health care interaction as the “post-intervention state of health.” The coded information may be added to the health care interaction database 20.

e. Apply a defined algorithm to assess the change in health.
The health care outcome assessment tool 22 may access the coded information for a particular patient and assess the patient's current state of health (i.e. post-intervention) as compared to the patient's pre-intervention state of health. The health care outcome assessment tool 22 may quantify the patient's change in health by indicating an improvement (+) or a declination (−) in health, as shown in Table 1. The quantified change in health may be stored in the quantified health change database 24.

f. Apply access properties to the record of the intervention.

1. Individual: elects to share with his friends a portion of his interaction, but keeps private certain details of the same intervention. (e.g. in the diet example, 30 decides to share his weight loss goals and progress with his friends, but keeps a private log of when he cheated)).

2. In a healthcare encounter, the shared portion of the physician's record becomes part of the institutional chart and certain elements are reported to the government and/or insurance company. The patient may wish to append or contribute to the official record of the encounter. Both perspectives form part of a digital “imprint” of the encounter. Follow-up observations/impressions related to a given issue are associated with the original encounter.

3. Inducements are offered to share as much of the data as the patient feels comfortable with the interactions database 20.
Access properties may be applied to the information related to the health care interaction. For example, the access properties (e.g., private, shared, public, etc.) may be associated with the information relevant to a particular patient stored in the health care interaction database 20 and/or the quantified health change database 24.

Example B illustrates a method of quantifying changes in health, based on both the patient's and the doctor's portions of the health care interaction.

Example B: Quantification of Changes in Health Based on Exchanged Information:

a. Individual A (e.g., patient) requests assistance from individual B (e.g., doctor).
A's request for assistance from B may be perceived via an initial health care interaction between the A and B. The interaction may be recorded using the sensor 50 and the request for assistance may be coded using the interaction coding/transcribing tool 60 as described herein. For example, the interaction coding/transcribing tool 60 may identify the request for assistance using word and/or context recognition techniques. The request for assistance may thus be associated with a code identifying the relevant portion of the health care interaction as the “request.” The coded information may be added to the health care interaction database 20.

b. Individual B accepts/declines request.
B's acceptance or denial of A's request for assistance is sensed, coded and stored in the health care interaction database 20.

c. Individual A describes objective of interaction.
The objective may be coded and stored in the health care interaction database 20.

d. Individual B clarifies if necessary.
Clarification and further details may be coded and stored in the health care interaction database 20.

e. Individual A confirms. This constitutes consent to proceed with health care interaction.
A's confirmation may be coded and stored in the health care interaction database 20.

f. A record of the interaction is made.
The interaction between A and B proceeds and may be sensed by sensor 50, coded by interaction coding/transcribing tool 60, and stored in the health care interaction database 20.

g. Access properties to the record of the intervention are applied.
Access properties may be applied to the information related to the interaction. For example, the access properties (e.g., private, shared, public, etc.) may be associated with the information relevant to a particular patient stored in the health care interaction database 20 and/or the quantified health change database 24.

h. Quantification of the changes in health is performed for both individual A and B.
The health care outcome assessment tool 22 may access the coded information from the interaction between A and B. Further, the health care outcome assessment tool 22 may access coded information related to health care perceptions (e.g., past or pre-intervention state of health) of both A and B. The health care outcome assessment tool 22 may quantify the patient's (e.g. A's) change in health, as perceived by both A and B, by indicating a perceived improvement (+) or decline (−) in health, for both A and B, as shown in Table 2. The quantified change in health may be stored in the quantified health change database 24.

As shown in Table 2, the quantified change in health may be indicated as one of: A−B+; A+B+; A−B−; A+B−. Generally, a change of health of A−B− would stop the interaction. This indicates that both A (e.g., patient) and B (e.g., doctor) perceive that A's health has changed for the worse. Thus, the current course of intervention or treatment should be stopped. On the other hand, A+B+ indicates an optimal outcome, i.e. an optimal change of health. A−B+ or A+B− indicates that caution should be used and additional optimization of the encounter may be necessary.

The process of patient and doctor interacting, sensing and coding these interactions and quantifying the change of health, as described herein, is an iterative process, played according to a set of rules in the form of a game. Different encounters may call for different rules. Identifying the context and individual roles for the interaction ahead of time ensures proper disclosure of the expectations on both A and B. The rules can be modified to suit the individual needs, but the modifications become part of the record of the interaction, so transparency protects against abuse. The game is “played” to the best of each individual's ability with an expectation that neither will be perfect, but that with practice and support, both individuals can “win” by naturally aligning what are traditionally considered separate agendas; the patient having their issue addressed, the physician trying to fit the patient into a recognized pattern and meet regulatory obligations—towards common goals (mutually improved health). Whereas traditionally, physicians are in a dominant position, they now are recognized as equal partners to the patient, with the patient being recognized as the most important “player” in any given health interaction. The physician's improvement in health is reflected not only in the financial reward they receive for their services, but in the improved “enjoyment” of their art and advancement of the science through the knowledge exchange that occurs with the empowered patient.

When the patient and physician interact, in the subsequent “coding” of the interaction (traditionally done through an often redundant combination of progress notes or dictated letters, physicians orders, etc.) becomes much more accurate with each issue identified forming a discrete entity that contains reference (links) to the observations and data that led to the identification of the issue, a hypothesis as to the root causes of the problem, and detailed plan for improvement with prospectively identified landmarks for re-assessment as well as a built-in mechanism for terminating the experiment if safety parameters are exceeded. Regardless of the treatment strategies employed, the sum of the contextual data as well as the universal binary measure of [−/+] change in health forms the basis for devising ever-more accurate approximations of the net health impact of a given interaction.

The system 10 may further include a patient device 70 and/or a third-party device 80. The patient device 70 and third-party device 80 may access the health care interaction database 20 through a variety of ways, including through a computerized device in communication with the system 10 over a network system. Other ways of accessing the health care interaction database 20 may include using a telephone, a cell phone, a PDA or another type of personal electronic device, any of which may be included in the patient device 70 and/or third-party device 80. An input device, such as a keyboard or mouse, may be used to input information into and/or request information from the health care interaction database 20 by either of the patient device 70 and/or the third-party device 80. The patient device 70 allows a patient 30 to access the health care interaction database 20, for example to view stored information associated with the patient, to transfer information, and the like. Depending on privacy settings, the patient 30 may wish to allow a third-party to access the patient's information stored on the health care interaction database 20.

As specified herein, the system 10 may include a number of other features to enhance the design, use or functionality of the system 10 to measure health care outcomes. These additional features may include functional or aesthetic components within the health care interaction database 20, such as website components, software based automation or the ability to tailor the system 10 to the preferences of a particular patient or doctor.

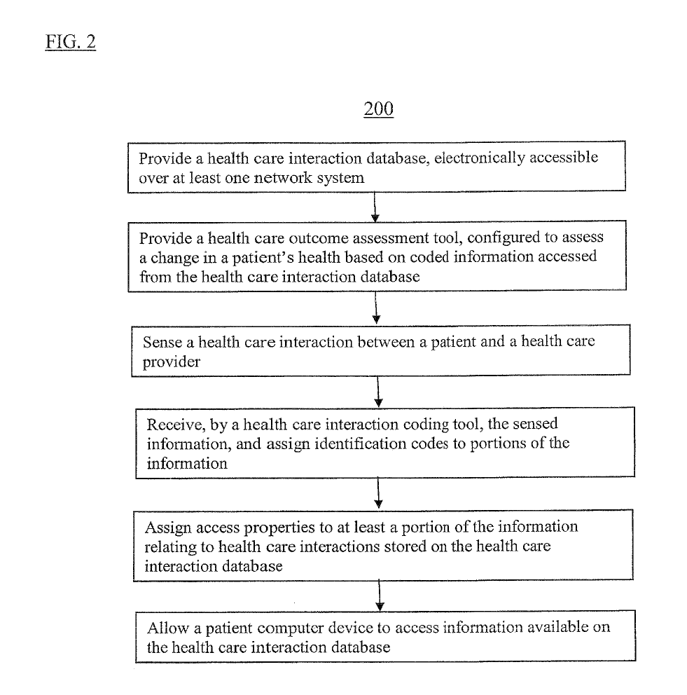

FIG. 2 is a flowchart 200 illustrating a method of measuring health care outcomes, in accordance with the first exemplary embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved.

As is shown by block 202, a health care interaction database 20 is provided. The health care interaction database 20 is electronically accessible over at least one network system 12. At block 204 a health care outcome assessment tool 22 is provided. The health care outcome assessment tool 22 is hosted at least partially on the health care interaction database 20, and is configured to assess a change in a patient's health based on coded information relating to a health care interaction accessed from the health care interaction database. At block 206, a health care interaction between a patient 30 and a health care provider 40 is sensed, for example by sensor 50. The sensed information may be provided to the health care interaction database 20. At block 208, the information sensed by the sensor 50 is received by a health care interaction coding tool 60, and the coding tool 60 assigns identification codes to portions of the information sensed by the sensor 50. At block 210, access properties are assigned to at least a portion of the information relating to health care interactions stored on the health care interaction database 20. At block 210, a patient computer device 70 is allowed to access information available on the health care interaction database 20.

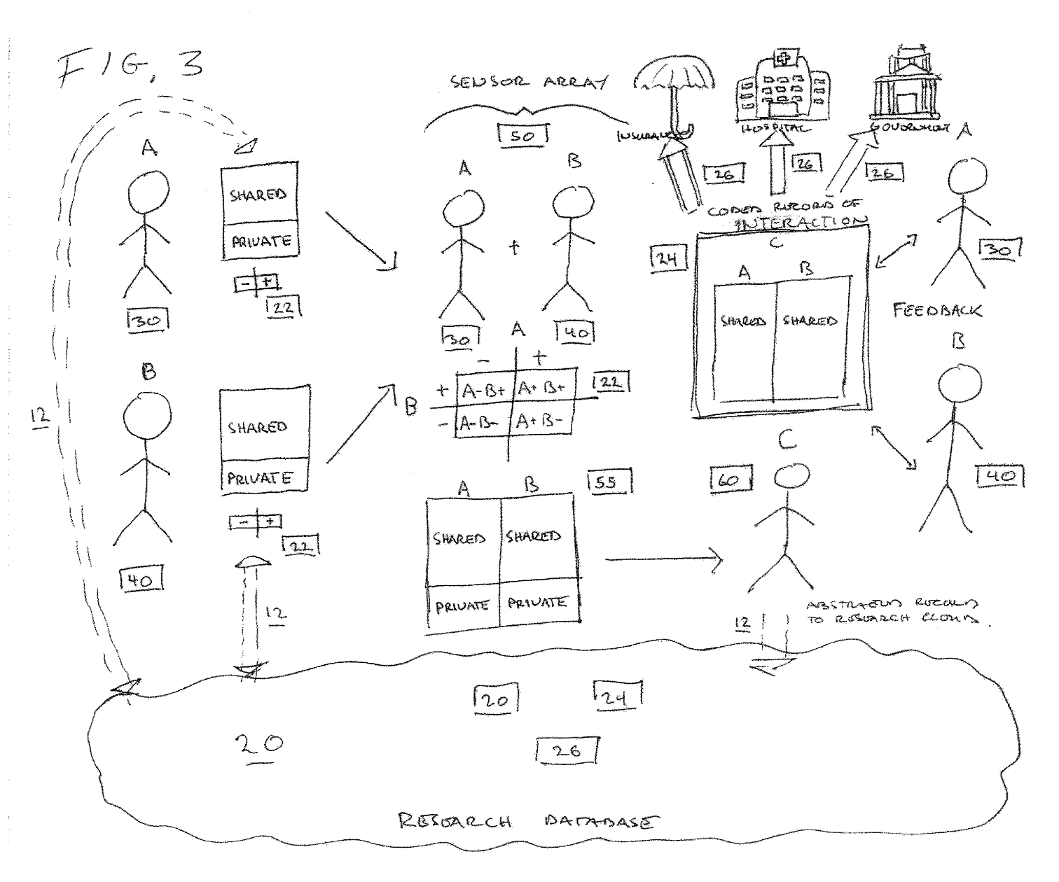

Another embodiment of the disclosure is illustrated in FIG. 3. Referring to FIG. 3, a first sensor array 50 (which could be thought of as the information array) represents the extrinsic contextual data that is presented to A and/or B ahead of or during the “human interaction” of the patient-physician visit, e.g. paper and/or electronic forms for subjectively documenting an individual's perceived health status and/or health-related interactions, interaction summaries, including nursing, physiotherapy, occupational therapy, social work, etc., vital signs, cbc, Light's criteria, bun/cr and radiology reports, e.g. from past 24 hr. Both A and B are able to customize which information is displayed to them and in what fashion, e.g. information array templates. These templates can be licensed, crowd sourced, and customized.

The [−/+] tool represents a type of binary “switch”, such as in a cell phone with an app that has a [−] and [+] input/switch that can be used to imprint the individual subjective impression at various times along the interaction. These become associated with the digital record of the encounter. At significant decision points along the encounter a “straw-poll” may be taken that records A and/or B's perception of a given idea/decision 22. The impression could be shared, e.g. “I consent to proceed with the treatment plans,” or kept private, e.g. “this guy is a jerk”. So, at various points along the interaction we have individual subjective “scores” attached to specific elements of the interaction. Also, for example, the patient may not wish to disclose an embarrassing episode, but may want to have a record of it in case it is part of a pattern. A care provider may wish to outline, but not prematurely disclose, their suspicions of secondary gains, abuse, etc.

The sensory array represented by 50 provides “context”, but the “subjective impression” forms a key part of the record of the intervention. Rather than the typical SOAP (Subjective, Objective, Assessment, Plan) methodology taught now, the focus would be on separating out for each issue addressed the key observations, hypothsis, and intervention in a manner that lends itself to machine learning and retrospective analysis. In essence, the present disclosure changes the paradigm from “big expensive randomized controlled trials” to “measure everything we can in a manner that will help us understand trends and answer questions as they come up”.

The record of the interaction 55 includes the shared summary of the encounter of both A (when able) and B along with a record of the information array (e.g., paper and/or electronic form, template or the like) used during the encounter and, when possible one or more disclosed digital records (audio/video) of the encounter enhanced by the individual subjective scores or place markers representing discrete issues/decisions made.

The coding process 60 represents a type of “debriefing” exercise and can be performed by any combination of A, B, and/or C (representing a skilled coder not directly involved in the encounter). This may be facilitated by a standardized algorithm (which may be crowd sourced) with the goal of having high inter-rater reproducibility. Feedback can be attached to the encounter and targeted for any one of the individual or group approved stakeholders permitted access to the encounter.

In hospitals, there typically is a skilled coder C who reviews the interaction. However, they rely only on the physicians observations and the coding is quite primitive. By providing “cleaner” and more contextualized data, much more detail could be extracted from the clinical record and these could enhance the efficient accounting of resource utilization for insurance companies, hospitals, government, etc.

Further, by creating a unique ID that is shared between A and B of the clinical encounter as well as the identified issues, bi-directional feedback is made possible. Also, the coder C can score the clinical encounter and provide constructive feedback to all parties.

The shared portion of the high-fidelity summary of the encounter or a portion of it is forwarded to the appropriate stakeholders (medical records, insurance claims, public health, library of health, etc.). The private portion remains the property of the individual authors.

An “abstract” of the encounter and the feedback and follow-up measures attached to it is added via 12 to a cloud database which serves to form a global repository of health interactions 20 to further the scientific (and social) study of the effectiveness of health interactions.

The overall process may be described as follows:

1. Individuals use a structured personal health log that helps them measure progress on any number of “health goals”. In the healthcare example, both the patient A and the provider B use the same structure for recording their observations. Part of this record can be shared, and part can be made private.

2. Interactions are conceptualized as occurring between two individuals, where A is the one initiating the interaction and B is the one being approached for the interaction. A record of the interaction is produced which consists of the sum of both individual's health log. There is a clear delineation between A and B's description of the encounter with possible reference to a common sensor array (e.g. digital recording, timestamp, geolocation, etc.)

3. The shared portion of the interaction is reviewed by a skilled coder C who extracts using an identified algorithm the elements of the interaction in a format that allows quantification of the outcome of the encounter. The quantification incorporates the perceived “change in health” of both A and B, but might also include total time taken, number of issues addressed, quality of shared portion of health log, adequate follow-up planning, prospective setting of realistic, measurable outcome goals, etc.

4. The coder's analysis is feedback to A and B as well as to any pre-defined regulatory/supervisory authority (e.g. hospital, government, etc.).

5. There is an inducement to share the coded output (anonymously, with obscured identifiers, or with full disclosure) to a research database that can be queries or mined for trends and used to refine the strategic intervention algorithms used for subsequent encounters.

Appendix A is an example of a transcribed health care interaction between a patient and a doctor, which includes some codes assigned to certain portions of the interaction.

As will be appreciated from the foregoing, the present disclosure provides a system for improving communication between a patient and a health care provider, and also for incentivizing a patient in terms of compliance, on the one hand, and a health care provider in terms of, for example, remuneration, on the other hand, which could, for example, be tied to a true approximation of the impact of their interactions with patients. The incentive for a patient then becomes shifted from blaming the health care provider to taking responsibility and control resulting in an improved outcome, and for health care providers then becomes shifted from “getting through my list so that I can get home”, or “seeing as many patients as I can to maximize billing”, to “how can I maximize the positive impact of my interaction with the patient in the most efficient manner possible.”

Yet other embodiments are contemplated. For example, once a method of coding and quantifying a given healthcare interaction are agreed upon, one can, with increasing frequency and improving accuracy, abstract the clinical profile from the user identity and feed massive amounts of data into a global database that can be used as a resource for machine learning/simulations/rapid prototyping. This has applications for everything from answering questions like “how many days of antibiotics should I prescribe for my patient” to “what is the best combination of chemotherapeutics for this particular patient and this particular cancer”, to “what is the likely source of this epidemic”. As such, it could provide a key to merging personalized medicine and global health. It also allows user-access and input to their medical records in a secure fashion.

This is similar to how Google will run “experiments” on their users by serving up slightly different variations of user interface/experience and measuring the reaction. The present disclosure could enable the same concept, but rather than the “search” experience, would be serving up (and/or retrospectively analyzing) treatment algorithms with enough contextual data and feedback to perform sub-group analysis.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. Individual health initiatives (e.g. diet, exercise, meditation) could be represented and measured by the individual and compared to interaction-based interventions. Also, the system permits the use of crowd sourcing and “organic evolution” of the algorithms underlying the process. An international consensus (e.g wikipedia, WHO) could serve as the foundation for definitions of the various sensor arrays, treatment algorithms, etc. But these can be modified by groups (e.g. hospitals/clinics/governments/insurance companies) or individuals (patients/physicians) to meet their needs. The modifications could be noted and optionally shared back as derivative works or licensed. Such modifications may provide incremental improvements at scale through an iterative process.

Also, the present disclosure provides an option of personal and/or walled data repositories existing in databases physically separate from the “cloud”, so as to address security concerns. For example, patients can store their records off line (on hard drive, paper journal, etc.); and hospitals/clinics/insurance can employ the system within their internal network with full control over the data.

All such modifications and variations are intended to be included herein within the scope of this disclosure and the present disclosure and protected by the following claims.

APPENDIX A

The following is a transcribed portion of a health care interaction between a doctor (B) and a patient (A). Codes have been assigned to identify certain portions of the interaction, in accordance with the present disclosure.

B: Alright. No names, no identifiers, just voice. Ready? [Step 1. Engage in individualized treatment contract including informed consent (in this case a discharged assessment of an acute adult medical inpatient. [B {+}= initiates and frames interaction]

A: I Got it. [A {+}=implicit consent to proceed]

B: What can I do to most efficiently reduce your suffering? [Objective=Clarify objective/goal of interaction]

A: Right now, is get me home. Because, that's what, because I don't have any suffering left. [A=sets objective]

B: I apologize for having taken 3 hours to get to you this morning. I was having too much fun with my other patients. [B=perceives and attempts to reduce harm of delayed discharge]

A: Laugh [A {+}]

B: Alright. So, let's make sure that we ah . . . we already covered before, I won't repeat it but your vitals are all good. Your pain is absolutely gone, been gone for a few days. [CC: Pain. Status Resolved B {+}]. You enjoyed some day passes on the weekend, had some good walks. [Descriptive detail to quantify outcome of intervention.] You're feeling back to normal. You said “better than you felt in a year”.

A: A couple of years. [A {+}. Code outcome of pain strategy for original chief complaint as successful, anonomyze and send to cloud]

B: A couple of years! [Improved health past pre-admission baseline B {+}] And you think you feel better because? [B Objective=elucidate patient's hypothesis as to source of improvement]

A: Because whatever was there is gone. [Patient perception=problem is solved A {+}, Physician knows that the problem remains B {−} flag raised to proceed with caution]. I think maybe there was a small infection, but not enough. [A concept of illness=infection B concept=possible malignancy. Both captured and considered on equal footing] Like, I don't know.

B: Did it get really quickly worse, or had it been brewing quietly in the background a long time.

A: It was brewing quietly in the background for a long time. I thought may be it was something to do with my cardio because I have cardio history and I've been asking my doctor questions about that there, but we haven't been able to find anything. But I feel like if I get out today I'll be going for a walk and maybe even a bike ride.

B: Thats the first step to feeling better for sure.

OK, so, yeah, I think the problem is usually when we break up the problem in chunks like that and we have to repeat the same questions, we end up repeating the questions. We are not very efficient at that. It is a system problem. [B=identify system issue, record created with reference to negative impact on patient] [B {−} with respect to System] How did what has been happening over the past year directly affect thou most importantly? [B=add context to description of problem]

A: I felt lethargic most of the time. You know, and I'm usually a get-up and goer. [A=add context to description of problem]

B: Are you working right now? [B=add context to patient profile]

A: Yeah, I'm usually a get-up and goer at work, and the last year or so it has taken all I have just to keep pace. So . . . [A=add context to patient profile]

B: OK, so now you are about to go home on a few new medications. The new one is another blood pressure pill, because your blood pressure went up a little bit we added Norvasc, now your blood pressure did go down.

A: mmmh mmmh

What is claimed is:

1. A system for measuring health outcomes comprising:
a health interaction database configured to store information relating to health interactions, electronically accessible over at least one network system; and
a health outcome assessment tool hosted at least partially on the health interaction database, wherein said health outcome assessment tool is configured to assess a change in a patient's health based on coded information relating to a health interaction accessed from the health interaction database.

2. The system of claim 1, further comprising a sensor for sensing a health interaction between a patient and a health provider, wherein information sensed by the sensor is provided to the health interaction database.

3. The system of claim 2, further comprising a health interaction coding tool, wherein the health interaction coding tool is configured to receive information sensed by the sensor and to assign identification codes to portions of the information sensed by the sensor.

4. The system of claim 3, wherein the assigned codes identify at least one of:
the identity of the parties involved in the health interaction; the nature of the interaction; the time of the interaction; the place of the interaction; the condition of the patient; the type of treatment administered; the objective of the treatment; and the effectiveness of the treatment.

5. The system of claim 1, wherein the assessed change in patient health is stored in a quantified change of health database.

6. The system of claim 5, wherein the quantified change of health database is hosted at least partially on the health care interaction database.

7. The system of claim 1, wherein the assessed change in patient health comprises a binary indication of either improved or declined health.

8. The system of claim 1, wherein the coded information relating to a health care interaction comprises information relating to a patient's perceived state of health and a doctor's perceived state of the patient's health.

9. The system of claim 1, wherein access properties are assigned to at least a portion of the information relating to health interactions stored on the health interaction database.

10. The system of claim 1, further comprising a license database having a plurality of preconfigured licenses for use of information stored in the health interaction database.

11. The system of claim 1, further comprising at least one patient computer device configured to allow a patient to access information available on the health interaction database.

12. A method for measuring health care outcomes, comprising the steps of:
providing a health care interaction database, electronically accessible over at least one network system; and
providing a health care outcome assessment tool hosted at least partially on the health care interaction database, wherein said health care outcome assessment tool is configured to assess a change in a patient's health based on coded information relating to a health care interaction accessed from the health care interaction database.

13. The method of claim 12, further comprising:
sensing a health care interaction between a patient and a health care provider; and
providing the sensed information to the health care interaction database.

14. The method of claim 13, further comprising:
receiving, by a health care interaction coding tool, information sensed by the sensor; and
assigning identification codes to portions of the information sensed by the sensor.

15. The method of claim 14, wherein the assigned codes identify at least one of:
the identity of the parties involved in the health care interaction; the nature of the interaction; the time of the interaction; the place of the interaction; the condition of the patient; the type of treatment administered; the objective of the treatment; and the effectiveness of the treatment.

16. The method of claim 12, wherein the assessed change in patient health is stored in a quantified change of health database.

17. The method of claim 16, wherein the quantified change of health database is hosted at least partially on the health care interaction database.

18. The method of claim 12, wherein the assessed change in patient health comprises a binary indication of either improved or declined health.

19. The method of claim 12, wherein the coded information relating to a health care interaction comprises information relating to a patient's perceived state of health and a doctor's perceived state of the patient's health.

20. The method of claim 12, further comprising:
assigning access properties to at least a portion of the information relating to health care interactions stored on the health care interaction database.

21. The method of claim 12, further comprising:
providing a license database having a plurality of preconfigured licenses for use of information stored in the health care interaction database.

22. The method of claim 12, further comprising:
allowing at least one patient computer device to access information available on the health care interaction database.

23. A non-transitory computer readable medium containing instructions for providing a method for measuring health care outcomes enabled at least in part on a processor of a computerized device, wherein a health care interaction database is electronically accessible by the processor, and a health care outcome assessment tool is hosted at least partially on the health care interaction database, the instructions, which when executed by the processor, performing the step of:
assessing a change in a patient's health based on coded information relating to a health care interaction accessed from the health care interaction database.

24. The non-transitory computer readable medium of claim 23, wherein the instructions, when executed by the processor, further perform the step of:
receiving, by a health care interaction coding tool, information sensed by a sensor; and
assigning identification codes to portions of the information sensed by the sensor, wherein the information sensed by the sensor relates to a health care interaction between a patient and a health care provider.

25. The non-transitory computer readable medium of claim 24, wherein the assigned codes identify at least one of: the identity of the parties involved in the health care interaction; the nature of the interaction; the time of the interaction; the place of the interaction; the condition of the patient; the type of treatment administered; the objective of the treatment; and the effectiveness of the treatment.

26. The non-transitory computer readable medium of claim 23, wherein the assessed change in patient health is stored in a quantified change of health database.

27. The non-transitory computer readable medium of claim 26, wherein the quantified change of health database is hosted at least partially on the health care interaction database.

28. The non-transitory computer readable medium of claim 23, wherein the assessed change in patient health comprises a binary indication of either improved or declined health.

29. The non-transitory computer readable medium of claim 23, wherein the coded information relating to a health care interaction comprises information relating to a patient's perceived state of health and a doctor's perceived state of the patient's health.

30. The non-transitory computer readable medium of claim 23, wherein the instructions, when executed by the processor, further perform the step of:
assigning access properties to at least a portion of the information relating to health care interactions stored on the health care interaction database.

31. The non-transitory computer readable medium of claim 23, wherein the instructions, when executed by the processor, further perform the step of:
allowing at least one patient computer device to access information available on the health care interaction database.
